(19) United States
(12) Patent Application Publication
(10) Pub. No.: US 2026/0333003 A1
(43) Pub. Date: Oct. 22, 2026

(54) METHOD OF TRANSMITTING ADVERTISING PACKETS, METHOD OF ESTABLISHING A WIRELESS LINK, ASSOCIATED ELECTRONIC DEVICE AND SYSTEM

(71) Applicant: VALEO COMFORT AND DRIVING ASSISTANCE, Créteil (FR)

(72) Inventor: Eric Leconte, Créteil (FR)

(73) Assignee: VALEO COMFORT AND DRIVING ASSISTANCE, Créteil (FR)

(21) Appl. No.: 19/122,048

(22) PCT Filed: Sep. 19, 2023
(86) PCT No.: PCT/EP2023/075783

§ 371 Date: Apr. 17, 2025

(30) Foreign Application Priority Data
Oct. 17, 2022 (FR) FR2210655

(51) Int. Cl. H04W 4/40; H04W 52/02

(52) U.S. Cl. CPC H04W 4/40; H04W 52/0258

(57) ABSTRACT

A first communication circuit provided on an electronic device transmits advertising packets to a second communication circuit provided on a vehicle. The second communication circuit operates in successive periods having a first predetermined duration and each including a listening phase, during which the second communication circuit detects an electromagnetic signal, and a rest phase, during which the second communication circuit is inactive. A transmission method disclosed herein includes: transmitting an advertising packet by the first communication circuit at a first time; determining a random value; and transmitting another advertising packet by the first communication circuit at a second time separated from the first time by a second duration determined as a function of the random value and included strictly between two consecutive multiples of the first duration.

### TECHNICAL FIELD

The present invention relates, in general, to the field of wireless exchanges between an on-board system, provided for example on a vehicle, and an electronic device, forming for example an identifier associated with this vehicle.

More particularly, it relates to a method of transmitting advertising packets, a method of establishing a wireless link, and an associated electronic device and system.

### TECHNOLOGICAL BACKGROUND

PEPS (for “Passive Entry—Passive Start”) systems are known in which the implementation of a function (such as unlocking the doors of a vehicle or starting such a vehicle) is conditional upon the presence of an electronic device forming an identifier of the user of the vehicle (generally carried by this user) in proximity to the vehicle.

For this purpose, the vehicle and the identifier may be provided with communication circuits designed to establish a wireless data exchange link in accordance with a communication protocol.

### SUMMARY OF THE INVENTION

In this context, a method of transmitting, by a first communication circuit provided on an electronic device, advertising packets to a second communication circuit provided on a vehicle is proposed, wherein the second communication circuit operates in successive periods having a first predetermined duration and each comprising a listening phase, during which the second communication circuit is capable of detecting an electromagnetic signal, and a rest phase, during which the second communication circuit is inactive, the method comprising the following steps:
transmission of an advertising packet by the first communication circuit at a first time;
determination of a random value;
transmission of another advertising packet by the first communication circuit at a second time separated from the first time by a second duration determined as a function of the random value and comprised strictly between two consecutive multiples of the first duration.

Thus, the transmission times of the two successive advertising packets are not separated by a duration which would be an exact multiple of the first duration (duration of the periods of operation of the second communication circuit) so that an advertising packet can be transmitted during a listening phase of the second communication circuit (Vernier principle).

Furthermore, the second time, at which the advertising packet designated above as “other advertising packet” is transmitted, depends on the above-mentioned random value, and will therefore be distinct (with some exceptions) from a corresponding transmission time used by another electronic device of the same design which may be in proximity (such as for example when two people each with a similar identifier approach the vehicle at the same time). Interference is thus avoided in the case of two such electronic devices being present in proximity to the vehicle.

Other possible features, without being limiting, taken individually or in all technically possible combinations, are the following:
the second duration, denoted Δt, satisfies n.T₀<Δt<(n+1).T₀, where T₀ is the first duration and n is an integer greater than or equal to 5 (or even greater than or equal to 9);
the method comprises a step of determining the second duration by adding or by subtracting, depending on the random value, the duration of the listening phase (denoted t_{ON} below) to/from the product of the first duration T₀ by an integer (which may be a predetermined integer, for example greater than or equal to 10, or an integer possibly depending on another random value);
the method comprises a step of determining the second duration by multiplying the first duration T₀ by a number dependent on the random value (the determination of the second duration may then comprise adding the duration t_{ON} of the listening phase, or a multiple of the duration of the listening phase, to the result of this multiplication);
the method comprises a step of determining the second duration by adding, to the product of the first duration T₀ by an integer (which may be a predetermined integer, for example greater than or equal to 10, or depend on another random value), the product of the duration of the listening phase t_{ON} by a non-zero relative integer dependent on the random value;
for each of said successive periods, the listening phase has a duration comprised between 5% and 30% of said first duration (that is to say the duration t_{ON} is comprised between 0.05.T₀ and 0.3.T₀).

The invention also proposes a method of establishing a wireless link between a first communication circuit provided on an electronic device and a second communication circuit provided on a vehicle, comprising the following steps:
implementation, by the first communication circuit, of a method of transmitting advertising packets as described above;
detection of one of said advertising packets by the second communication circuit during a listening phase;
in response to the detected advertising packet, transmission, by the second communication circuit, of a connection request;
establishment of a connection between the first communication circuit and the second communication circuit.

Correspondingly, the invention proposes an electronic device comprising a control unit and a first communication circuit designed to transmit advertising packets to a second communication circuit provided on a vehicle, the second communication circuit operating in successive periods having a first predetermined duration and each comprising a listening phase, during which the second communication circuit is capable of detecting an electromagnetic signal, and a rest phase, during which the second communication circuit is inactive, wherein the control unit is designed to determine a random value and to determine, as a function of the random value, a second duration comprised strictly between two consecutive multiples of the first duration, and wherein the first communication circuit is designed to transmit an advertising packet at a first time and another advertising packet at a second time separated from the first time by the second duration.

Finally, the invention proposes a system comprising an electronic device as just indicated and an on-board system comprising the second communication circuit.

Of course, the various features, variants and embodiments of the invention can be combined with one another in various combinations, provided that they are not incompatible with one another or mutually exclusive.

### BRIEF DESCRIPTION OF THE FIGURES

The description that follows with reference to the appended drawings, which are given by way of non-limiting examples, will allow of what the invention consists and how it may be carried out to be clearly understood.

In the appended drawings:

FIG. 1 schematically shows the main elements of a system in which the invention can be implemented;

FIG. 2 shows an example of a method of transmitting advertising packets which can be implemented within the framework of the system of FIG. 1; and

FIG. 3 shows an example of a method of establishing a wireless link.

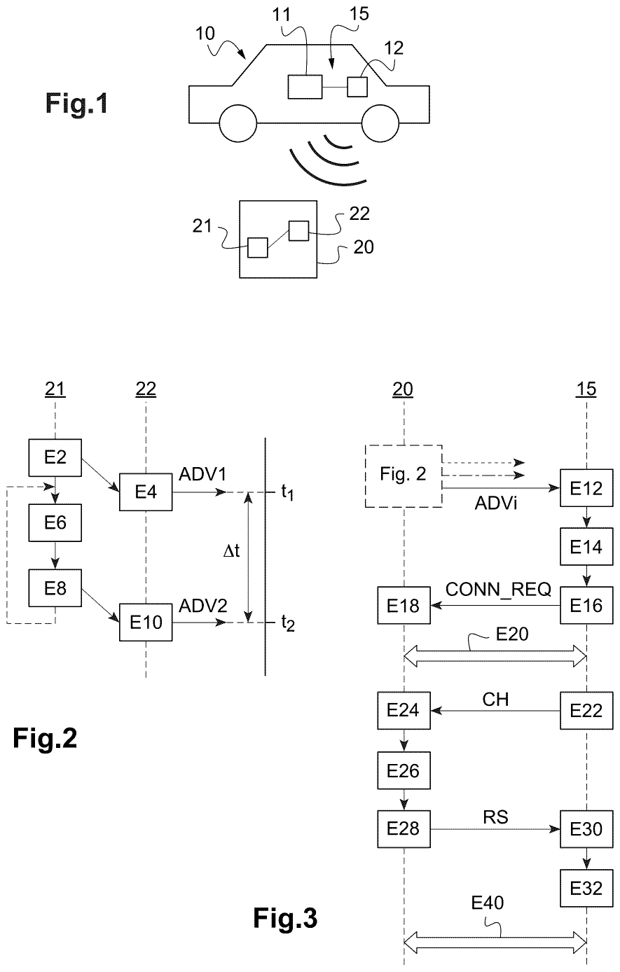

FIG. 1 schematically shows the main elements of a system in which the invention can be implemented.

Such a system comprises a vehicle 10, here an automotive vehicle, and an electronic device 20 used as an identifier, for example a key or badge for accessing the vehicle 10 (or, as a variant, a user terminal, such as a multifunctional mobile telephone—or “smartphone”, provided with access rights to the vehicle 10).

The vehicle 10 is provided with an on-board system 15 comprising, in particular, an electronic control unit 11 and a communication circuit 12.

The electronic control unit 11 comprises, for example, a microprocessor and at least one memory, for example a rewritable non-volatile memory. The memory stores, in particular, program instructions which, when they are executed by the microprocessor, allow the electronic control unit 11 to implement the method described below with reference to FIG. 3. The memory may also store values or parameters used during these methods.

The memory of the electronic control unit 11 additionally stores a cryptographic key K (which has for example been written into the electronic control unit 11 during the manufacture thereof).

As a variant, the electronic control unit 11 could be embodied in the form of an application-specific integrated circuit (or ASIC).

The communication circuit 12 is designed to establish a wireless link with other electronic devices, in this case a link of “Bluetooth Low Energy” (or “BLE”) type. The communication circuit 12 is therefore in particular designed to transmit and receive electromagnetic signals (typically with a frequency higher than 1 MHz, or even 500 MHz), in this case in the 2.4 GHz band.

As a result, for example, of commands received from the electronic control unit 11, the communication circuit 12 performs successive operating periods having a predetermined duration T₀ and/or each comprising a listening phase, during which the communication circuit 12 is capable of detecting an electromagnetic signal, and a rest phase, during which the communication circuit 12 is inactive. In other words, the operation of the communication circuit 12 is periodic, each operating period (of predetermined duration T₀) comprising a listening phase and a rest phase as defined above. The rest phases make it possible to reduce the average electrical consumption of the communication circuit 12 and thus of the on-board system 15.

The predetermined duration T₀ of the operating periods is for example comprised between 10 ms and 200 ms, and here is 100 ms.

Over each operating period, the duration of the listening phase is for example comprised between 5% and 30% of the operating period. It is noted below t_{ON} the duration of a listening phase. (The duration t_{ON} is therefore in this case comprised between 0.05.T₀ and 0.3.T₀.)

The electronic device 20, generally carried by a user of the vehicle 10, is used as an identifier for authorizing and/or allowing the control of certain functions of the vehicle 10 (for example unlocking the doors of the vehicle 10), in particular when it is brought close to the vehicle 10. The electronic device 20 may possibly further comprise control buttons which the user can use to control at least some of the aforementioned functions or other functions of the vehicle 10.

The electronic device 20 comprises a control unit 21 and a communication circuit 22.

The control unit 21 is, for example, embodied by means of a microprocessor and at least one memory, for example a rewritable non-volatile memory. The memory stores, in particular, program instructions which allow, when they are executed by the microprocessor, the control unit 21 to implement the method described below with reference to FIG. 2 and/or the method described below with reference to FIG. 3. The memory may also store values or parameters used during these methods.

The memory of the control unit 21 also additionally stores the cryptographic key K. In the case in which the electronic device 20 forming an identifier is a badge (or key) for accessing the vehicle, the cryptographic key K has for example been written into the memory of the control unit 21 during the manufacture of the identifier 20. In the variant mentioned above in which the electronic device 20 forming an identifier is a user terminal, the cryptographic key K has for example been received from a remote server and stored during a registration phase for a service for controlling vehicle functions by means of the user terminal.

It is noted that, in the embodiment described here, the cryptographic key K stored in the memory of the control unit 21 is identical to the cryptographic key K stored in the memory of the electronic control unit 11. However, as a variant, the cryptographic key K stored in the memory of the control unit 21 could be different from the cryptographic key K stored in the memory of the electronic control unit 11, for example in the context of the use of a public key infrastructure (or PKI).

As a variant, the control unit 21 could be embodied in the form of an application-specific integrated circuit.

The communication circuit 22 is designed to establish a wireless link (in this case of “Bluetooth Low Energy” or “BLE” type) with other electronic devices, in particular with the electronic control unit 11 of the vehicle 10 via the communication circuit 12 mentioned above. The communication circuit 22 is therefore itself also designed to transmit and receive electromagnetic signals (typically with a frequency higher than 1 MHz, or even 500 MHz), in this case in the 2.4 GHz band.

By virtue of the wireless link which can thus be established between the communication circuit 12 of the on-board system 15 of the vehicle 10 and the communication circuit 22 of the electronic device 20, as described below, data can be exchanged between the electronic control unit 11 of the on-board system 15 of the vehicle 10 and the control unit 21 of the electronic device 20.

The electromagnetic signals exchanged between the communication circuits 12, 22 can furthermore be used to evaluate the distance separating the electronic device from the vehicle 10 (precisely the distance separating the communication circuits 12, 22), as also explained below.

FIG. 2 shows an exemplary method of transmitting advertising packets which can be implemented within the framework of the system that has just been described.

Advertising packets are electromagnetic signals, located for example in a predefined frequency band and/or having a predefined shape in accordance with the communication protocol used, in this case the BLE protocol.

This method begins at step E2 during which the control unit 21 commands the communication circuit 22 to transmit an advertising packet ADV1 at a time t₁. The advertising packet ADV1 is, for example, the first advertising packet transmitted after a restart of the electronic device 20 (for example following its powering up) and the time t₁ is, for example, a predefined time of the restart process.

The communication circuit 22 thus transmits, in step E4, the advertising packet ADV1 at the time t₁ and in accordance with the BLE protocol.

The method continues to step E6 during which the control unit 21 determines a random value a, for example in the case described here by calling upon a dedicated function (random drawing function) within the microprocessor forming the control unit 21.

The control unit 21 then commands, in step E8, the communication circuit 22 to transmit an advertising packet ADV2 at a time t₂ separated from the first time t₁ by a duration Δt determined as a function of the random value a and comprised strictly between two consecutive multiples of the predetermined duration T₀ (duration of each operating period of the communication circuit 12 as explained above).

In other words, the duration Δt separating the time t₁ of transmission of the packet ADV1 and the time t₂ of transmission of the packet ADV2 depends on the random value a and satisfies:
n.T₀<Δt<(n+1).T₀, where n is an integer greater than or equal to 2, and preferably greater than or equal to 5.

In practice, the duration Δt can be determined according to one of the methods now proposed. It is considered in these examples that the random value a determined in step E6 is comprised between 0 and 1 (that is to say obtained by random drawing over the interval [0, 1]).

According to a first possible method, the duration Δt is determined as follows:
Δt=m.T₀+t_{ON} if a>0.5,
Δt=m.T₀−t_{ON} if a<0.5,
where m is a predetermined integer (greater than or equal to 3, and preferably greater than or equal to 6) and where t_{ON} is, as already indicated, the duration of each listening phase.

According to a second possible method, the duration Δt is determined as follows:
Δt=m.T₀+2.t_{ON} if a>0.5,
Δt=m.T₀+t_{ON} if a≤0.5,
where m is a predetermined integer (greater than or equal to 2, and preferably greater than or equal to 5) and where t_{ON} is, as already indicated, the duration of each listening phase.

According to a third possible method, the duration Δt is determined as follows:
Δt=INT(5+5a).T₀+t_{ON}
where INT is the “integer part” function and where t_{ON} is, as already indicated, the duration of each listening phase.

According to a fourth possible embodiment, step E6 further comprises the determination of another random value b and the duration Δt is determined as follows:
Δt=INT(5+5a).T₀+T_{ON} if b>0.5,
Δt=INT(5+5a).T₀−t_{ON} if b≤0.5.

The communication circuit 22 then transmits, in step E10, the advertising packet ADV2 at the time t₂ and in accordance with the BLE protocol.

The method can then loop back to step E6 with a view to transmitting a new advertising packet.

By virtue of the method that has just been described, two successive advertising packets are transmitted at respective times separated by a duration Δt which satisfies the conditions set out above proposed for the advertising packet ADV2, namely that this duration Δt depends on a random value (which may be different for each packet transmitted) and is comprised strictly between two consecutive multiples of the predetermined duration T₀ (it being possible for the pair of consecutive multiples in question to be distinct from one packet to the other).

Thus, for each advertising packet ADVi transmitted, the duration Δt separating the transmission of this advertising packet ADVi from the preceding packet satisfies:
n.T₀<Δt<(n+1).T₀, where n is an integer greater than or equal to 2, and preferably greater than or equal to 5 (it being possible for n to vary from one advertising packet to the other as already indicated).

The advertising packets are thus transmitted less frequently than provision is made for the listening phases of the communication circuit 12, this making it possible to reduce the electrical consumption at the electronic device 20.

Moreover, the advertising packets are not transmitted with a period identical to the period T₀ of repetition of the listening phases so as to ensure that an advertising packet occurs (possibly after transmission of a plurality of advertising packets) during a listening phase (Vernier principle).

Finally, the transmission time of the advertising packets (during step E8) depends on a random value (determined in step E6) so that two electronic devices of the type of the electronic device 20 and of the same design (this being the case, for example, when two users of the vehicle carry two similar identifiers, respectively) will transmit (with some exceptions) an advertising packet at distinct times, this making it possible to avoid interference between these two electronic devices in their exchanges with the communication circuit 12 provided on the vehicle.

The advertising packets ADV1, ADV2 mentioned above are in this case of the ADV_IND type: these are advertising packets indicating availability for a connection and not specifically directed to a communication partner (or “connectable undirected advertising event”).

The advertising packets ADV1, ADV2, ADVi transmitted by the communication circuit 22 of the electronic device 20 may include data, in particular identification data ID of the electronic device 20.

FIG. 3 shows an example of a method of establishing a wireless link between the communication circuit 12 provided on the vehicle and the communication circuit 22 of the electronic device 20 forming an identifier.

This method begins with the transmission of advertising packets by the communication circuit 22 of the electronic device 20 in accordance with what has just been described with reference to FIG. 2.

When the vehicle 10 is sufficiently close to the electronic device 20 (this usually occurring when the carrier of the electronic device 20 approaches the vehicle 10), the communication circuit 12 of the on-board system 15 of the vehicle 10 detects (and therefore receives) one of the advertising packets ADVi and thus indicates to the electronic control unit 11 the arrival of this advertising packet ADVi (step E12). The communication circuit 12 may also transmit, in this step, the data possibly included in the advertising packet ADVi (in particular the identification data ID of the electronic device 20) to the electronic control unit 11.

The electronic control unit 11 may then command, in step E14, the communication circuit 12 to respond to the advertising packet ADVi transmitted by the electronic device 20, typically by transmitting a connection request CONN_REQ to the communication circuit 22 of the identifier 20 (step E16).

According to one possible embodiment, the transmission of the connection request CONN_REQ by the communication circuit 12 (on command of the electronic control unit 11) may however be conditional upon by the presence of the identification data ID of the electronic device 20 within a list of previously paired identifiers (this list being stored in the memory of the electronic control unit 11, the identification data of a given electronic device being added to this list by means of a specific pairing process).

The communication circuit 22 of the electronic device 20 receives the connection request CONN_REQ in step E18. A wireless link can thus be set up between the on-board system 15 and the identifier 20 in step E20 by means of the establishment of a connection between the communication circuit 12 of the on-board system 15 and the communication circuit 22 of the identifier 20 in accordance with the communication protocol in question (here the BLE protocol already mentioned).

Within the framework of this connection established in accordance with the communication protocol in question, provision is made, as already indicated, for time slots dedicated to data exchanges (such as for example during steps E22 to E30 described below) between the communication circuit 12 of the on-board system 15 and the communication circuit 22 of the electronic device 20.

According to one possible embodiment, the data exchanged between the electronic device 20 and the on-board system 15 are encrypted (typically by means of a cryptographic encryption algorithm, using for example the cryptographic key K shared by the electronic control unit 11 and the control unit 21 as already indicated) during their exchange between the communication circuit 12 of the on-board system 15 and the communication circuit 22 of the electronic device 20. The encryption used is, for example, that provided in the context of the data exchange protocol in question D, here the BLE protocol.

Possible exchanges of data between the electronic device 20 and the on-board system 15 will now be described, still with reference to FIG. 3.

During a step E22, the electronic control unit 11 of the on-board system 15 determines a value CH (for example by random drawing) and commands the communication circuit 12 to transmit this value CH via the established wireless link (between the communication circuit 12 and the communication circuit 22), and thus to the electronic device 20 (that is to say in practice to the control unit 21). As explained below, this value CH is used as a challenge in a challenge-response exchange in order to verify that the electronic device 20 does indeed possess the cryptographic key K.

The control unit 21 receives the value CH via the communication circuit 22 (step E24).

During step E26, the control unit 21 applies to the value CH a cryptographic processing algorithm (for example an encryption algorithm) using the cryptographic key K so as to obtain a response RS intended for the on-board system 15.

The control unit 21 then commands (step E28) the communication circuit 22 to transmit the response RS via the wireless link established (between the communication circuit 12 and the communication circuit 22), and thus to the electronic control unit 11.

The electronic control unit 11 therefore receives the response RS in step E30, via the communication circuit 12.

The electronic control unit 11 can thus verify the received response RS in step E32, here by applying to the response RS a cryptographic processing algorithm, for example a decryption algorithm, using the cryptographic key K, and by verifying whether the result obtained is indeed identical to the value CH sent in step E22.

If (and only if) the verification is correctly performed in step E32 (this demonstrating that the electronic device actually stores the cryptographic key K), the electronic device 20 is authenticated by the electronic control unit 11; the electronic control unit 11 can then authorize certain actions such as unlocking the vehicle 10.

Moreover, the electronic control unit 11 and/or the control unit 21 can control (to the communication circuit 12 and/or to the communication circuit 22, respectively) the transmission of electromagnetic signals and/or the performance of measurements (step E40) so as to evaluate the distance separating the communication circuit 12 from the communication circuit 22, in accordance for example with what is described in the patent application published under the reference FR 3 081 637.

1. A transmission method of transmitting, by a first communication circuit provided on an electronic device, advertising packets to a second communication circuit provided on a vehicle, wherein the second communication circuit operates in successive periods having a first predetermined duration and each comprising a listening phase, during which the second communication circuit detects an electromagnetic signal, and a rest phase, during which the second communication circuit is inactive, the transmission method comprising:
transmitting an advertising packet by the first communication circuit at a first time;
determining a random value; and
transmitting another advertising packet by the first communication circuit at a second time separated from the first time by a second duration determined as a function of the random value and comprised strictly between two consecutive multiples of the first duration.

2. The transmission method as claimed in claim 1, wherein the second duration, denoted Δt, satisfies n.T₀<Δt<(n+1).T₀, where T₀ is the first duration and n is an integer greater than or equal to 5.

3. The transmission method as claimed in claim further comprising determining the second duration by adding or by subtracting, depending on the random value, the duration of the listening phase to/from a product of the first duration by an integer.

4. The transmission method as claimed in claim comprising of determining the second duration by multiplying the first duration by a number dependent on the random value.

5. The transmission method as claimed in claim 1, comprising determining the second duration by adding, to a product of the first duration by an integer, the product of the duration of the listening phase by a non-zero relative integer dependent on the random value.

6. The transmission method as claimed in claim 1 wherein, for each of said successive periods, the listening phase has a duration comprised between 5% and 30% of said first duration.

7. A method of establishing a wireless link between a first communication circuit provided on an electronic device and a second communication circuit provided on a vehicle, comprising:
implementing, by the first communication circuit, the method of transmitting advertising packets as claimed in claim 1;
detecting one of said advertising packets by the second communication circuit during a listening phase;
transmitting, in response to the detected advertising packet, by the second communication circuit, a connection request; and
establishing a connection between the first communication circuit and the second communication circuit.

8. An electronic device comprising:
a control unit; and
a first communication circuit configured to transmit advertising packets to a second communication circuit provided on a vehicle,
wherein the second communication circuit operating in successive periods having a first predetermined duration and each comprising a listening phase, during which the second communication circuit detects an electromagnetic signal, and a rest phase, during which the second communication circuit is inactive,
wherein the control unit is configured to determine a random value and to determine, as a function of the random value, a second duration comprised strictly between two consecutive multiples of the first duration, and
wherein the first communication circuit is configured to transmit an advertising packet at a first time and another advertising packet at a second time separated from the first time by the second duration.

9. A system comprising: an electronic device as claimed in claim 8; and an on-board system comprising the second communication circuit.
